(19) United States
(12) Patent Application Publication
(10) Pub. No.: US 2010/0225680 A1
(43) Pub. Date: Sep. 9, 2010

(54) IMAGE DISPLAYING APPARATUS

(75) Inventor: Kenichi Kido, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/718,283

(22) Filed: Mar. 5, 2010

(30) Foreign Application Priority Data
Mar. 6, 2009 (JP) 2009-054114

(51) Int. Cl. G09G 5/10

(52) U.S. Cl. 345/690

(57) ABSTRACT

An image displaying apparatus includes a display with delta array. If an image is displayed on the basis of image data in an RGB format arrayed in a stripe pattern, data of color values R, G and B are input to a calculator. The calculator performs a weighted average on color values of adjacent pixels in a lateral direction to calculate each color value, and a rearranger rearranges calculated respective color values so as to conform to the delta array. Then, a driver displays an image on the basis of the color values which are rearranged so as to conform to the delta array.

### CROSS REFERENCE OF RELATED APPLICATION

The disclosure of Japanese Patent Application No. 2009-054114 is incorporated herein by reference.

### BACKGROUND OF THE INVENTION

1. Field of the Invention

The present invention relates to an image displaying apparatus. More specifically, the present invention relates to an image displaying apparatus displaying an image on an LCD monitor.

2. Description of the Related Art

Conventionally, an image displaying apparatus displaying an image on an LCD monitor is known.

As one example of the related art, when RGB data of a vertical stripe array is displayed on a display panel with a delta pixel array, a screen display is performed by developing the RGB data in vertical two lines (V direction) and laying out them. Thus, this driving apparatus can perform the screen display by an original aspect ratio.

However, in the related art, the RGB data of the vertical stripe array is laid out in the vertical two lines, resulting in degradation in image quality.

### SUMMARY OF THE INVENTION

Therefore, it is a primary object of the present invention to provide a novel image displaying apparatus.

In one aspect of the invention, an image displaying apparatus comprises a display with delta array which displays an image being made up of a plurality of pixels; a calculator which calculates each color value for display by changing weights of color values of adjacent pixels in a lateral direction out of the plurality of pixels; a rearranger which rearranges the color values for display calculated by the calculator so as to conform to the delta array; and a displayer which displays the image on the display on the basis of the color values for display rearranged by the rearranger.

An image displaying apparatus is a digital camera, for example, and has a display. The display is an LCD monitor in which display elements are arrayed in a delta pattern, for example. A calculator calculates a color value by changing weights of color values of the adjacent pixels in a lateral direction and averaging them in order to conform the image signal arrayed in a stripe pattern in the RGB format to the LCD monitor arrayed in a delta pattern. Furthermore, a rearranger rearranges the respective calculated color values so as to be brought into correspondence with the display elements of the delta array. The displayer is an LCD driver for driving the display, for example, and displays the image based on the color values which are rearranged so as to conform to the delta array.

In another aspect of the invention, the plurality of pixels comprises odd-numbered lines and even-numbered lines, and the calculator makes the weight of the latter pixel larger than that of the former pixel out of the adjacent pixels with respect to the odd-numbered line, and makes the weight of the former pixel larger than that of the latter pixel out of the adjacent pixels with respect to the even-numbered line.

With respect to the display elements of the LCD monitor, each of the even-numbered line is displaced with respect to the odd-numbered line by half the element, so that as to the odd-numbered lines, the weight of the latter pixel out of the adjacent pixels is made larger than the weight of the former pixel, and as to the even-numbered lines, the weight of the former pixel out of the adjacent pixels is made larger than that of the latter pixel.

The above described objects, features, and advantages of the present invention will become more apparent from the following detailed description of the present invention when taken in conjunction with the accompanying drawings.

### BRIEF DESCRIPTION OF THE DRAWINGS

FIG. 1 is a block diagram showing a digital camera of one embodiment of the present invention;

FIG. 2 is an illustrative view showing a part of an array of display elements on an LCD monitor shown in FIG. 1;

FIG. 3 is an illustrative view showing a configuration of a conversion circuit shown in FIG. 1 and a peripheral section of the conversion circuit;

FIG. 4 is an illustrative view showing one example of a configuration of image data in an RGB format to be output from a memory control circuit shown in FIG. 3;

FIG. 5 is an illustrative view showing one example of data interpolation by a data interpolation circuit shown in FIG. 3;

FIG. 6 is an illustrative view showing barycentric positions of the display elements shown in FIG. 2; and

FIG. 7 is an illustrative view showing one example of rearrangement by a data rearrangement circuit shown in FIG. 3.

### DETAILED DESCRIPTION OF THE PREFERRED EMBODIMENTS

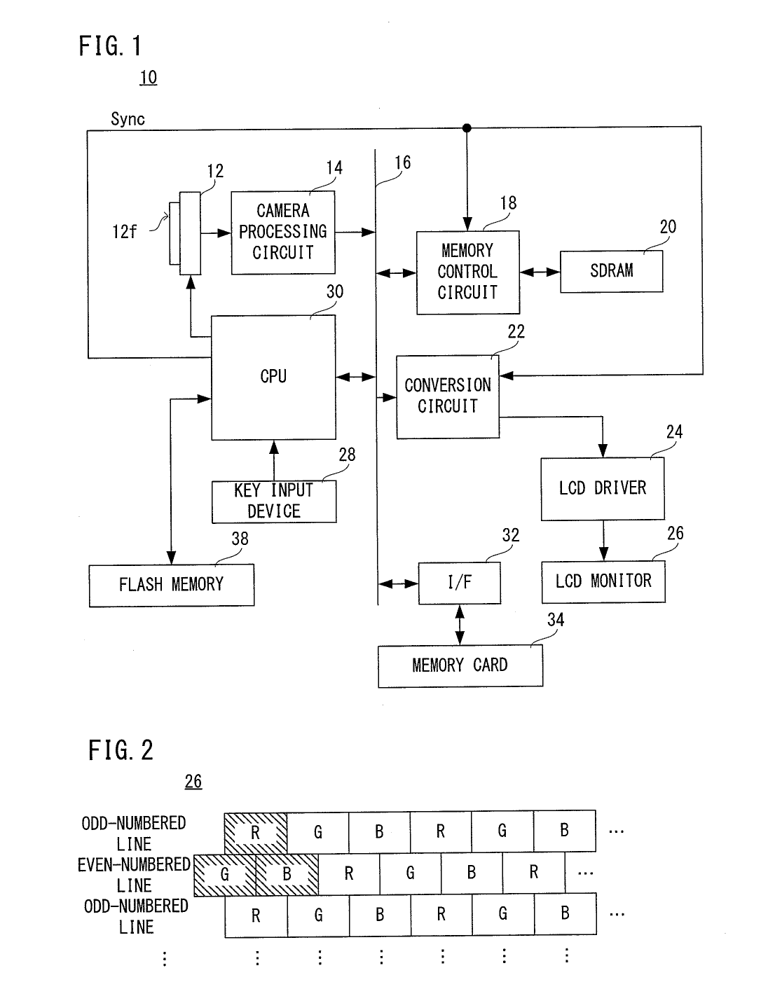

Referring to FIG. 1, a digital camera 10 of this embodiment includes an image sensor 12. An optical image of an object scene is irradiated onto the image sensor 12. On an imaging area 12f of the image sensor 12, a photoreceptor corresponding to 1600×1200 pixels, for example, is set, and on the imaging area 12f, electric charges corresponding to the optical image of the object scene, that is, a raw image signal of 1600×1200 pixels is generated by a photoelectronic conversion.

When a power source of the digital camera 10 is turned on, a CPU 30 instructs the image sensor 12 to repeat a pre-exposure and a thinning-out reading in order to display a real-time motion image, that is, a through image of the object on an LCD monitor 26 being a display apparatus. The image sensor 12 repetitively executes the pre-exposure and the thinning-out reading of the raw image signal thus generated in response to a synchronization signal (Vsync) which is generated for each 1/30 seconds. A raw image signal of a low resolution, 320×240 pixels, for example, corresponding to the optical image of the object scene is output from the image sensor 12 at a frame rate of 30 fps.

For example, the output raw image signal is subjected to processing, such as an A/D conversion and a color separation by the camera processing circuit 14 to generate image data in an RGB format, and the image data in the RGB format is converted into image data in a YUV format. The created image data in the YUV format is written to an SDRAM 20 in this format by a memory control circuit 18. Moreover, the image data in the YUV format is converted into image data in the RGB format arrayed in a stripe pattern by a matrix circuit provided to the memory control circuit 18 and then written to the SDRAM 20 again.

Thereafter, the image data in the RGB format which is arrayed in the stripe pattern is read by the same memory control circuit 18, and the read image data in the RGB format is converted into image data in the RGB format which is arrayed in a delta pattern by a conversion circuit 22. An LCD driver 24 functioning as a displayer drives the LCD monitor 26 when image data in the RGB format which is arrayed in the delta pattern is input. Consequently, a through-image of the object scene is displayed on the LCD monitor 26.

Here, each of a plurality of pixels which makes up of pixel image data includes three pigment levels (color values) of R (red), G (green) and B (blue). Each of the three pigment levels is represented by 8 bits (0-255), and thus, the number of colors represented by the image data is 16,777,216 colors.

Furthermore, when a shutter operation is performed by the key input device 28, the CPU 30 executes main imaging processing, specifically performs predetermined signal processing on the raw image signal of 1600×1200 pixels output from the image sensor 12 to temporarily store the resultant in the SDRAM 20, and the CPU 30 instructs an I/F 32 to perform recording processing with respect to a memory card 34. The I/F 32 reads image data from the SDRAM 20 through a bus 16 and a memory control circuit 18, and records as an image file including the read image data in the memory card 34. Here, the memory card 34 is detachable, and is made accessible when it is attached to a slot (not illustrated) by the I/F 32.

Additionally, the CPU 30 converts the image data in the RGB format to image data in the delta array described later by bringing an operation of the memory control circuit 18 into synchronization with an operation of the conversion circuit 22. Furthermore, a flash memory 38 stores a program necessary for operating the digital camera 10, and the program is read partially and sequentially as required and processed by the CPU 30.

FIG. 2 is an enlarged view of the LCD monitor 26 with delta array of this embodiment. Referring to FIG. 2, on the display screen of the LCD monitor 26, a plurality of display elements are arranged, and the display screen is constructed by odd-numbered lines and even-numbered lines. Furthermore, on the display screen of the LCD monitor 26, a R color filter having a property of transmitting a red light component, a G color filter having a property of transmitting a green light component, and a B color filter having a property of transmitting a blue light component are formed. In FIG. 2, the letter of “R” is given to the display element on which the R color filter is formed, the letter of “G” is given to the display element on which the G color filter is formed, and the letter of “B” is given to the display element on which the B color filter is formed.

Additionally, in this embodiment, the display element on which the R color filter is defined as an R display element, the display element on which the G color filter is formed is defined as a G display element, and the display element on which the B color filter is formed is defined as a B display element.

For example, at the left end of the first odd-numbered line, an R display element is arranged, and followed by G and B display elements in the right direction. Thereafter, each display element is repetitively arranged from R, G, to B in this order. Furthermore, at the left end of the second even-numbered line, a G display element is arranged, and followed by B, R display elements in the right direction. Thereafter, each display element is repetitively arranged from G, B to R in this order. Then, as to the third line onward, the display elements are arranged such that the first line and the second line are alternately repeated.

Then, the even-numbered line is displaced to the left by half an element with respect to the odd-numbered line, and one pixel is represented by the three display elements which are diagonally shaded and are given the letter of R, G and B, respectively, and the respective R, G, and B display elements are arrayed in a delta pattern.

R color filters, G color filters and B color filters are also formed on the photosensitive elements provided to the imaging area 12f of the photoreceptor similar to the display elements of the LCD monitor 26.

Here, if the image data in the RGB format which is arrayed in the stripe pattern recorded in the SDRAM 20 is directly displayed on the LCD monitor 26 with delta array, the arrangement of the image signals is different, resulting in image degradation. Thereupon, in this embodiment, the image data in the RGB format which is arrayed in the stripe pattern is converted so as to conform to the LCD monitor 26 with delta array by the conversion circuit 22, and then the converted image data is displayed on the LCD monitor 26.

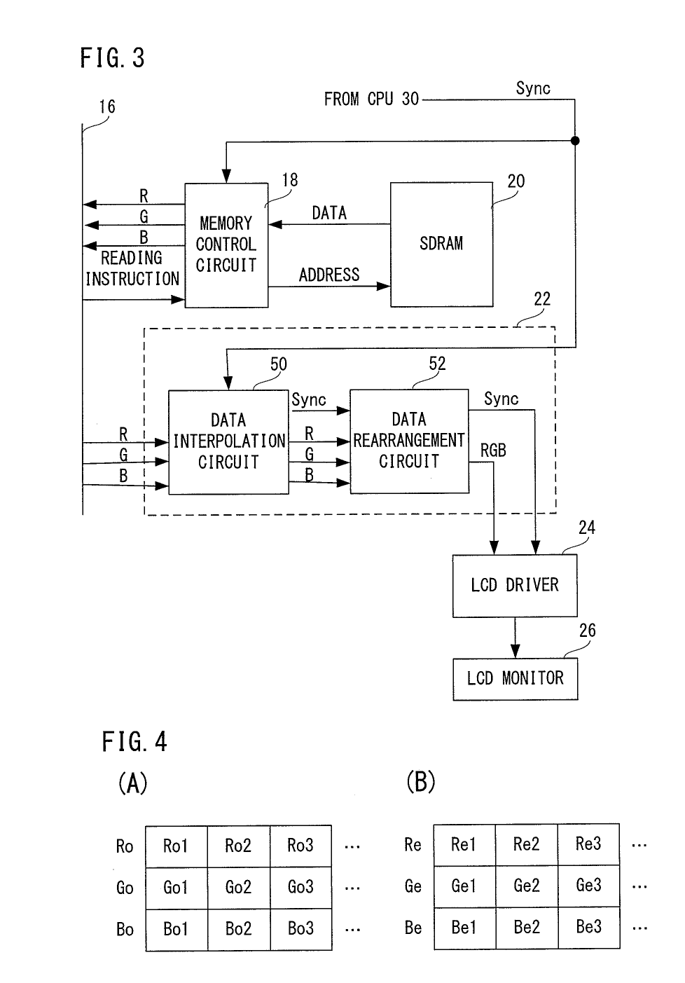

Referring to FIG. 3, when displaying the image on the LCD monitor 26, the CPU 30 instructs the memory control circuit 18 to read the image data in the RGB format, and instructs a signal generator 36 to send a Sync signal. When receiving the reading instruction and the Sync signal, the memory control circuit 18 sets memory addresses indicating the image data in the RGB format existing in the SDRAM 20. The memory control circuit 18 outputs the image data in the RGB format to the conversion circuit 22 via the bus 16 on the basis of the memory address.

As shown in FIG. 4(A) and FIG. 4(B), the image data in the RGB format is constructed of an RGB image signal of the stripe array. The RGB image signal of the odd-numbered line is constructed of an image signal of Ro, an image signal of Go and an image signal of Bo. Furthermore, the arrangement of the image signals of Ro, Go, and Bo of the RGB image in the odd-numbered line corresponds to a raster scanning direction (right direction) of the odd-numbered line from the upper left of the imaged image.

On the other hand, the RGB image signal of the even-numbered line is constructed of an image signal of Re, an image signal of Ge and an image signal of Be. Furthermore, the arrangement of the image signals of Re, Ge, and Be of the RGB image in the even-numbered line corresponds to a raster scanning direction of the even-numbered line from the upper left of the imaged image.

Returning to FIG. 3, the conversion circuit 22 includes a data interpolation circuit 50 functioning as a calculator and a data rearrangement circuit 52 functioning as a rearranger. Each image signal is input to the data interpolation circuit 50. When the Sync signal is input, the data interpolation circuit 50 calculates a color value for each of the R, G and B in synchronous with the operation of the memory control circuit 18 by changing weights of color values of the adjacent pixels in a lateral direction and adding the changed color values. Furthermore, the data interpolation circuit 50 outputs the calculated color values of R, G and B to the data rearrangement circuit 52 together with the input Sync signal. That is, the data interpolation circuit 50 calculates a color value by one pixel by utilizing color values of two pixels for each of the R, G, and B.

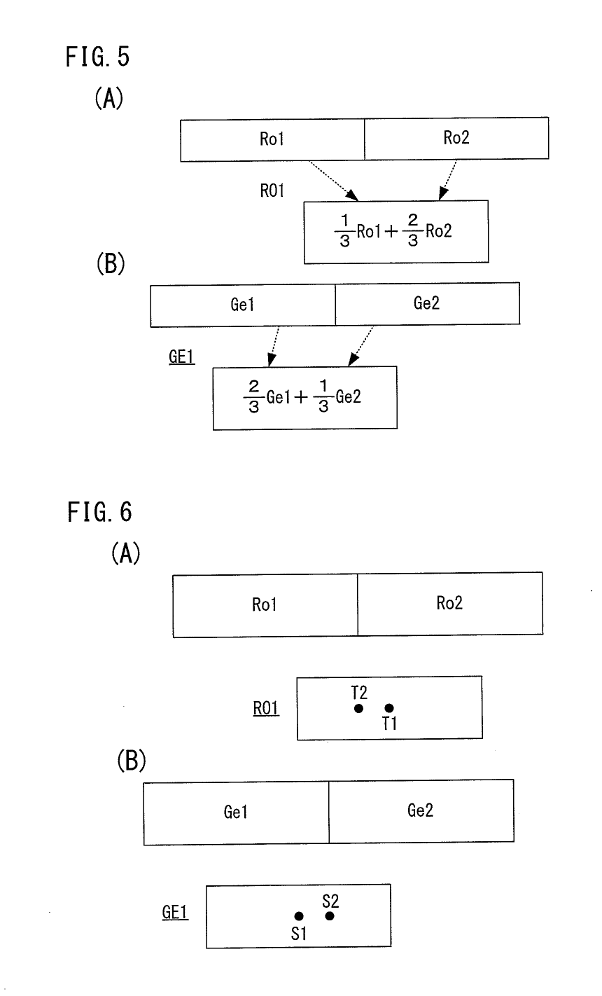

For example, the data interpolation circuit 50 calculates a color value of the odd-numbered line and a color value of the even-numbered line which are made up of the display pixels with the delta array from the color values of the odd-numbered line and the color values of the even-numbered line, respectively as shown in FIG. 5(A) and FIG. 5(B). Referring to FIG. 5(A), the display pixel RO1 of the delta array is arranged with respect to the signal pixels Ro1 and Ro2 of the stripe array so as to be displaced by one third the pixel in the direction of the signal pixel Ro1, and displaced by two third the pixel in the direction of the signal pixel Ro2.

In such a delta array, as shown in FIG. 6(A), a barycentric point T1 of the display pixel RO1 leans to the side of the signal pixel Ro2 of the stripe array, and thus is not coincident with a barycentric point T2 which is calculated by simply averaging the signal pixel Ro1 and the signal pixel Ro2. That is, in a case that the value calculated by simply averaging the signal pixel Ro1 and the signal pixel Ro2 is the color value of the display pixel RO1, red of the signal pixel Ro1 is intensely reproduced. Accordingly, in this embodiment, the signal pixel Ro1 and the signal pixel Ro2 are subjected to a weighted average based on the Equation 1 to thereby evaluate a color value of the display pixel RO1. The Equation 1 indicates that with respect to the odd-numbered line, the calculation is made such that the weight of the latter pixel out of the adjacent pixels is larger than that of the former pixel. Furthermore, for purpose of convenience, in the Equation 1 and the Equation 2 described later, the reference marks indicating the pixels are used as symbols for representing the color values of the pixels.

$$RO 1 = \frac{1}{3} Ro 1 + \frac{2}{3} Ro 2 \qquad [ Equation 1 ]$$

For example, if the color value of the signal pixel Ro1 is 150, and the color value of the signal pixel Ro2 is 120, the color value of the RO1 is 130.

On the other hand, referring to FIG. 5(B), the display pixel GE1 of the delta array is arranged with respect to the signal pixels Ge1 and Ge2 of the stripe array so as to be displaced by two third the pixel in the direction of the signal pixel Ge1, and be displaced by one third the pixel in the direction of the signal pixel Ge2.

Here, similar to the odd-numbered lines, as shown in FIG. 6(B), the barycentric point S1 of the display pixel GE1 is not coincident with a barycentric point S2 calculated by simply averaging the signal pixel Ge1 and the signal pixel Ge2. That is, in a case that the value calculated by simply averaging the signal pixel Ge1 and the signal pixel Ge2 is a color value of the display pixel GE1, green of the signal pixel Ge2 is intensely reproduced. Accordingly, in this embodiment, similar to the odd-numbered lines, the signal pixel Ge1 and the signal pixel Ge2 are subjected to a weighted average based on the Equation 2 to thereby evaluate a color value of the display pixel GE1. The Equation 2 indicates that with respect to the even-numbered line, the calculation is made such that the weight of the former pixel out of the adjacent pixels is larger than that of the latter pixel.

$$GE 1 = \frac{2}{3} Ge 1 + \frac{1}{3} Ge 2 \qquad [ Equation 2 ]$$

For example, if the color value of the signal pixel Ge1 is 150, and the color value of the signal pixel Ge2 is 120, the color value of the display pixel GE1 is 140.

Returning to FIG. 3, the data rearrangement circuit 52 rearranges the color values of R, G, and B thus calculated so as to conform to the LCD monitor 26 with delta array, and outputs the same with the input Sync signal to the LCD driver 24. That is, the data rearrangement circuit 52 rearranges the calculated color value so as to conform to the delta array. Then, the LCD driver 24 displays the image on the LCD monitor 26 on the basis of the color values rearranged by the data rearrangement circuit 52.

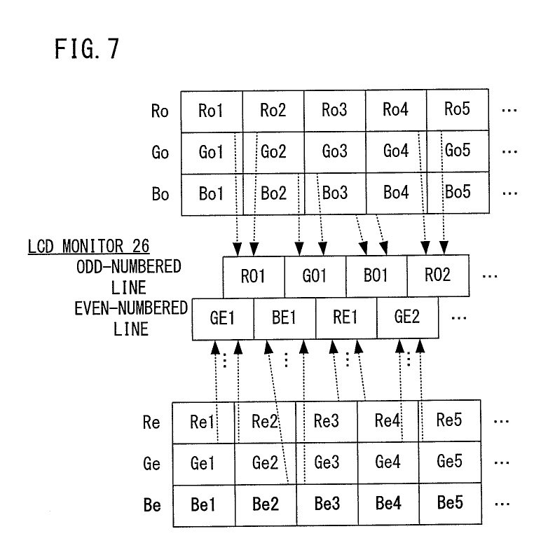

More specifically, referring to FIG. 7, in the odd-numbered line, the display pixels RO1, GO1, BO1 and RO2 . . . are arranged in this order, and in the even-numbered line, the display pixels GE1, BE1, RE1 and GE2 . . . are arranged in this order. Then, to the display pixel RO1 at the left end of the odd-numbered line, the color value obtained by performing a weighted average on the color values of the signal pixel Ro1 and the signal pixel Ro2 shown in FIG. 4(A) is set. Furthermore, to the display pixel GO1, the color value obtained by performing a weighted average on the color values of the signal pixel Go2 and the signal pixel Go3 is set, and to display pixel BO1, the color value obtained by performing a weighted average on the color values of the signal pixel Bo3 and the signal pixel Bo4 is set. In addition, to the display pixel RO2, the color value obtained by performing a weighted average on the color values of the signal pixel Ro4 and the signal pixel Ro5 is set.

On the other hand, to the display pixel GE1 at the left end of the even-numbered line, the color value obtained by performing a weighted average on the color values of the signal pixel Ge1 and the signal pixel Ge2 shown in FIG. 4(B) is set. Furthermore, similar to the odd-numbered line, to the display pixel BE1, the color value obtained by performing a weighted average on the color values of the signal pixel Be2 and the signal pixel Be3 is set, and to the display pixel RE1, the color value obtained by performing a weighted average on the color values of the signal pixel Re3 and the signal pixel Re4 is set. In addition, to the display pixel GE2, the color value obtained by performing a weighted average on the color values of the signal pixel Ge4 and the signal pixel Ge5 is set.

As understood from the above description, the digital camera 10 includes the LCD monitor 26 with delta array, and image data in the RGB format generated by the image sensor 12 and the camera processing circuit 14 is stored in the SDRAM 20 by the memory control circuit 18. Furthermore, in a case that an image is displayed on the LCD monitor 26, color value data of R, G, and B are input to the conversion circuit 22. In the conversion circuit 22, the data interpolation circuit 50 changes the weight of the color values of the adjacent pixels in a lateral direction in which raster scanning is performed to thereby calculate a color value, and the calculated respective color values calculated are rearranged so as to conform to the delta array in the data rearrangement circuit 52. Then, the LCD driver 24 displays the image on the basis of the color values which are rearranged so as to conform to the delta array.

Thus, the respective pixels of the image signal to be displayed are subjected to a weighted average and then rearranged, and thus, the digital camera 10 can display the RGB image signal of the stripe array on the LCD monitor 26 with delta array with degradation of image quality reduced.

Furthermore, the odd-numbered lines and even-numbered lines of the image signal are properly subjected to a weighted average, and therefore, the rearranged color values conform to the displacement of the odd-numbered lines and the even-numbered lines of the delta array.

In addition, for example, when the image data in the RGB format arranged in a stripe pattern is displayed on the LCD monitor 26 with delta array, a method of thinning-out the RGB image signal is conceivable. In this case, a reading data rate of the RGB image signal from the SDRAM 20 takes a time twice as long as an outputting data rate of the RGB image signal to the LCD monitor 26. However, by performing the weighted average on the RGB image signal as in this embodiment, it is possible to make the reading data rate of the RGB image signal from the SDRAM 20 and the outputting data rate of the RGB image signal to the LCD monitor 26 equal. Thus, in the digital camera 10 according to this embodiment, it is possible to make less power consumption than ever.

Additionally, in the conversion circuit 22, with respect to a reproduced image, such as a still image, a motion image, etc. as well as the through-image, the image can be converted so as to be displayed on the LCD monitor 26 with delta array. That is, the image to be displayed is not limited to the image imaged by the camera.

Furthermore, in this embodiment, after the image data in the YUV format is converted into the image data in the RGB format in the matrix circuit, the data is written to the SDRAM 20. However, a memory line is provided between the matrix circuit and the bus 16, and the image data in the RGB format may be written to the SDRAM 20, and then input to the data interpolation circuit 50.

In addition, the present invention may be applied to portable terminals, such as a mobile phone having a camera function and a laptop PC and a PDA (Personal Digital Assistant) having a Web camera as well as the digital camera 10. In addition, the present invention may be applied to a portable image displaying apparatus without camera capable of reproducing a motion image like a portable DVD player, and a mobile phone and a portable terminal which are able to acquire motion image data via a network.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image displaying apparatus, comprising:
a display with delta array which displays an image being made up of a plurality of pixels;
a calculator which calculates each color value for display by changing weights of color values of adjacent pixels in a lateral direction out of the plurality of pixels;
a rearranger which rearranges the color values for display calculated by the calculator so as to conform to the delta array; and
a displayer which displays the image on the display on the basis of the color values for display rearranged by the rearranger.

2. An image displaying apparatus according to claim 1, wherein
the plurality of pixels comprises odd-numbered lines and even-numbered lines, and the calculator makes the weight of the latter pixel larger than that of the former pixel out of the adjacent pixels with respect to the odd-numbered lines, and makes the weight of the former pixel larger than that of the latter pixel out of the adjacent pixels with respect to the even-numbered lines.
